(19) United States
(12) Patent Application Publication
(10) Pub. No.: US 2026/0016997 A1
(43) Pub. Date: Jan. 15, 2026

(54) NON-TRANSITORY COMPUTER READABLE STORAGE MEDIUM, INFORMATION PROCESSING DEVICE, AND SYSTEM

(71) Applicant: BROTHER KOGYO KABUSHIKI KAISHA, Nagoya (JP)

(72) Inventors: Aiko Yasui, Nagoya (JP); Ryoko Okamoto, Nagoya (JP); Tetsuya Nose, Nagoya (JP); Ryoji Ban, Kiyosu (JP); Jun Yamada, Nagoya (JP); Fuyuko Ito, Nagoya (JP)

(21) Appl. No.: 19/336,389

(22) Filed: Sep. 22, 2025

Related U.S. Application Data
(63) Continuation of application No. PCT/JP2024/010735, filed on Mar. 19, 2024.

(30) Foreign Application Priority Data
Mar. 31, 2023 (JP) 2023-058396

(51) Int. Cl. G06F 3/12

(52) U.S. Cl. CPC G06F 3/1205; G06F 3/1255

(57) ABSTRACT

A non-transitory computer readable storage medium storing a program configured to be executed by an information processing device configured to connect to a label printer. The program includes instructions that, when executed by a computer of the information processing device, causes the computer to execute acquisition processing of acquiring a print condition corresponding to a predetermined content from a server, and saving processing of saving the print condition acquired in the acquisition processing in association with the predetermined content. A print condition for each content configured to be included in label data is configured to be registered to the server. In a case where the server received a request related to the predetermined content from the information processing device, the server responds the print condition corresponding to the predetermined content to the information processing device.

### REFERENCE TO RELATED APPLICATIONS

This is a continuation application of International Application No. PCT/JP2024/010735 filed on Mar. 19, 2024, which claims priority from Japanese Patent Application No. 2023-058396 filed on Mar. 31, 2023. The entire contents of the aforementioned applications are incorporated herein by reference.

### BACKGROUND ART

In a related art, as a system for sharing contents, a system is known in which a server for saving contents is prepared on the Internet and the contents is downloaded to a device of a user.

In a points management system disclosed in the related art, photograph data is uploaded from a PC of a user A to a WWW server, and the photograph data is purchased by a PC of a user B and downloaded from the WWW server.

In recent years, a system for sharing label data used for printing a label in a label printer has been studied. The label data includes various contents, and some print conditions are suitable for printing depending on the contents. The related art discloses a system for sharing photograph data via a WWW server, but does not disclose print conditions suitable for printing contents included in label data.

### SUMMARY

A non-transitory computer readable storage medium storing a program configured to be executed by an information processing device configured to connect to a label printer,
in which the program including instructions that, when executed by a computer of the information processing device, causes the computer to execute:
   acquisition processing of acquiring a print condition corresponding to a predetermined content from a server; and
   saving processing of saving the print condition acquired in the acquisition processing in association with the predetermined content,
a print condition for each content configured to be included in label data is configured to be registered to the server,
in a case where the server received a request related to the predetermined content from the information processing device, the server responds the print condition corresponding to the predetermined content to the information processing device, and
the instructions cause the computer of the information processing device to further execute, in a case where the predetermined content in which the print condition is saved is used, adjustment processing of performing adjustment to satisfy the saved print condition.

### BRIEF DESCRIPTION OF DRAWINGS

FIG. 1 is a diagram schematically illustrating a label data sharing system.

FIG. 2 is a diagram schematically illustrating a terminal.

FIG. 3 is a diagram illustrating an example of a user database.

FIG. 4 is a diagram illustrating an example of content database.

FIG. 5 is a sequence diagram illustrating steps of downloading contents.

FIG. 6 is a sequence diagram illustrating steps of editing and posting label data.

FIG. 7 is a diagram illustrating an example of a label database.

FIG. 8 is a sequence diagram illustrating steps of downloading label data.

FIG. 9 is a sequence diagram illustrating an example of steps of printing.

FIG. 10 is a flowchart illustrating an example of a procedure of label editing.

FIG. 11 is a flowchart illustrating an example of a procedure of print adjustment.

### DESCRIPTION

Hereinafter, embodiments embodying a program used in a system for sharing label data will be described in detail with reference to the accompanying drawings. The present embodiment discloses a label data sharing system in which a server and a plurality of information processing devices are connected via a network to share label data used for printing a label in a label printer.

### [Configuration of Label Data Sharing System]

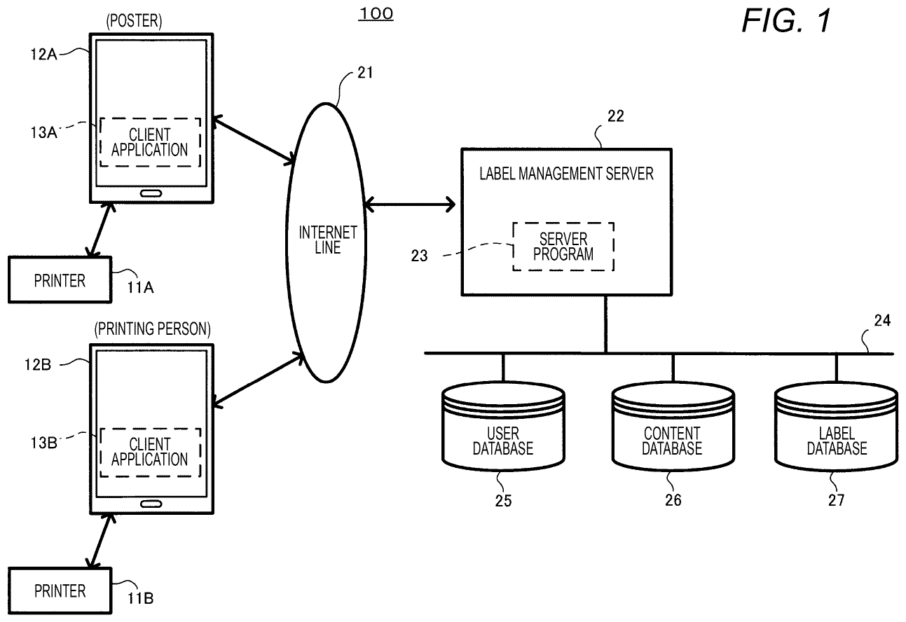

As illustrated in FIG. 1, a label data sharing system 100 (hereinafter abbreviated as “system 100”) according to the present embodiment is, for example, a system provided to a user by the vendor of the label printer. The system 100 includes a terminal 12A, a terminal 12B, and a label management server 22, which are connected via an Internet line 21. The terminals 12A and 12B are terminals owned by the owner or the user of the label printer. The terminals 12A and 12B is configured to be connected to label printers 11A and 11B, respectively.

The terminals 12A and 12B are information processing devices having a communication function, a display function, and an operation function. The terminals 12A and 12B according to the present embodiment are implemented with smartphones, and may be implemented with tablets or desktop computers. The terminals 12A and 12B is configured to store client application programs (hereinafter referred to as “client applications”) 13A and 13B, respectively. The number of terminals connected to the label management server 22 is not limited to the present embodiment. In addition, the terminals 12A and 12B may be collectively referred to as a “terminal 12” if it is not particularly necessary to distinguish them. The client applications 13A and 13B may be collectively referred to as a “client application 13” if it is not particularly necessary to distinguish them. In addition, the label printers 11A and 11B may be collectively referred to as a “label printer 11” if it is not particularly necessary to distinguish them.

The client application 13 is an application program provided by the vendor of the label printer 11. The client application 13 has a function of creating and editing label data on the terminal 12. The client application 13 further has a function of posting, that is, uploading, the created label data to the label management server 22 and a function of downloading the label data from the label management server 22. The client application 13 further has a function of uploading contents that can be arranged on a label to the label management server 22 and a function of downloading the contents from the label management server 22. The client application 13 has a function of printing the label data created on the terminal 12 and the downloaded label data using the label printer 11.

The terminal 12 is an example of an “information processing device”. The label management server 22 is an example of a “server”. The client application 13 is an example of a “program”. The Internet line 21 is an example of a “network”.

The label printer 11 is, for example, a printing device that includes a thermal transfer printhead and performs printing while unwinding a tape-shaped print medium wound in a roll shape. For example, the label printer 11 is configured to print an image on the accommodated print medium and convey the print medium, based on a print job received from the terminal 12, and cause the printed portion to protrude to the outside of the machine. A label having a predetermined label length and a predetermined label width is created with the print medium protruding to the outside of the machine. The “label width” is a dimension in a direction orthogonal to a direction in which the label is conveyed out from the label printer 11, that is, a width direction. The “label length” is the length in the direction in which the label is conveyed out from the label printer 11, that is, the size in the length direction.

The label printer 11 is connected to the terminal 12 by wireless LAN communication such as Wi-Fi (registered trademark) or short-range wireless communication such as Bluetooth (registered trademark). The label printer 11 and the terminal 12 may be connected by wire using the USB communication standard.

There are a plurality of types of print media usable in the label printer 11. For example, the type of the print medium may be distinguished depending on the width of the print medium, the color of the print medium or the ink, or the material of the print medium or the presence or absence of special processing. Models of label printers compatible with the tape are determined in advance depending on the type of the print medium. The user can replace the label printer with a print medium of a type suitable for the purpose or application among a plurality of types of print media compatible with the model of the label printer to perform printing.

The label management server 22 is a device having at least a storage function and a communication function. The label management server 22 is configured to store various programs such as a server program 23 and various data. The server program 23 has a function as a web server and is configured to provide various web pages. For example, the terminal 12 is configured to display various screens provided from the server program 23 by displaying the web page with a browser, and is configured to accept various inputs via the screens.

The label management server 22 is configured to access various databases, for example, is configured to access a user database (hereinafter referred to as “user DB”) 25, a content database (hereinafter referred to as “content DB”) 26, and a label database (hereinafter referred to as “label DB”) 27. The user DB 25, the content DB 26, and the label DB 27 may be included in the label management server 22 or may be included in a server different from the label management server 22. The user DB 25, the content DB 26, and the label DB 27 may be included in the same server or may be included in different servers. Details of the user DB 25, the content DB 26, and the label DB 27 will be described later. The server program 23 can execute various types of processing while accessing these databases.

### [Configuration of Terminal]

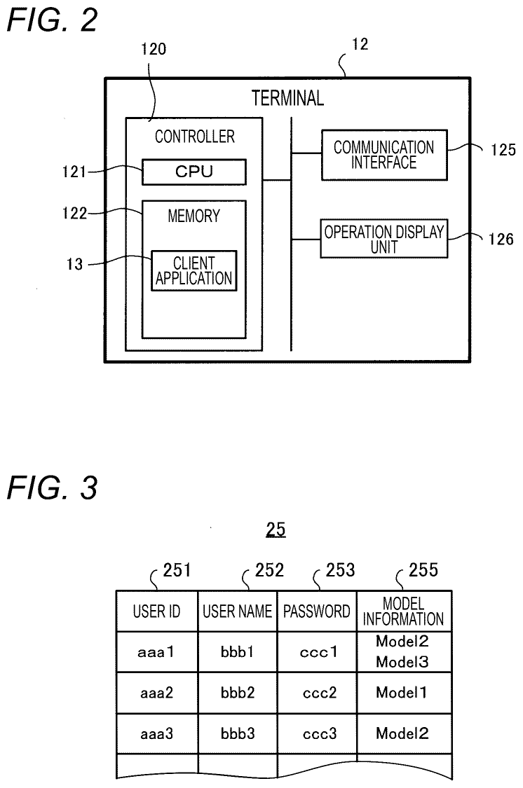

As illustrated in FIG. 2, the terminal 12 includes a controller 120 including a CPU 121 and a memory 122. The terminal 12 includes a communication interface (hereinafter referred to as a “communication IF”) 125 and an operation display unit 126, which are connected to the controller 120. The CPU 121 is an example of a “computer”. The controller 120 may be an example of a “computer”.

The CPU 121 is configured to execute various types of processing, in accordance with a program read from the memory 122 and based on a user's operation. The memory 122 is a storage area storing various programs such as the client application 13 and various data. The memory 122 is used as a work area when executing various types of processing.

Examples of the memory 122 illustrated in FIG. 2 are not limited to a ROM, a RAM, an HDD, and the like incorporated into the device, and may be a storage medium readable and writable by the CPU 121. The storage medium readable by the CPU 121 includes a recording medium such as a CD-ROM and a DVD-ROM in addition to the above examples.

The operation display unit 126 includes hardware configured to display a screen for notifying a user of information, and hardware configured to accept an operation from the user. The operation display unit 126 may be a touch panel having both a display function and an operation accepting function, or may be a set of a display having a display function and a keyboard, a mouse, a trackball, or the like having an operation accepting function.

The communication IF 125 includes hardware for communicating with an external device such as the label management server 22. Communication standards of the communication IF 125 include USB, Ethernet (registered trademark), Wi-Fi (registered trademark), and the like. The communication mode of the communication IF 125 may be wired or wireless. The communication IF 125 of the present embodiment is connected to the Internet line 21.

### [Operation of System]

Next, the operation of the system 100 will be described. In the system 100, the posted label data is shared by uploading the label data from the terminal 12 to the label management server 22 or downloading the posted label data from the label management server 22 to the terminal 12. The posted label data is the uploaded label data. The content that can be included in the label is shared in the same manner as the label data.

When the system 100 is used, there are various steps such as user registration, registration and download of contents, post and download of label data, and editing and printing of label data. These steps will be sequentially described below.

The steps in the terminal 12 in the present embodiment basically indicate processing of the CPU 121 according to a command described in programs such as the client application 13. The processing by the CPU 121 also include hardware control using APIs of the OS. In the present specification, a detail description of the OS is omitted, and an operation of each program is described. The steps in the label management server 22 also basically indicate processing of the CPU of the label management server 22 according to a command described in programs such as the server program 23.

### (1. User Registration Step)

First, a user registration step for registering information on a user who uses the system 100 in the user DB 25 will be described. A user who uses the system 100, for example, installs the client application 13 in the terminal 12, and then performs user registration in the label management server 22 via the client application 13.

For example, when the terminal 12 requests the label management server 22 to perform user registration via the client application 13, the label management server 22 requests input of a user name, a password, and a model name. Thereafter, upon accepting a registration instruction of the user in a state where such information is input via the client application 13, the label management server 22 registers new user information in the user DB 25 based on the input information.

Specifically, as illustrated in FIG. 3, information on the user who uses the system 100 can be registered in the user DB 25. The record of the user registered in the user DB 25 includes a user ID 251, a user name 252, a password 253, and model information 255. Upon accepting the registration instruction of the user, the label management server 22 creates a record in which the input user name, password, and model name are associated with the user ID for identifying the user, and newly registers the record in the user DB 25. Thus, the user registration procedure is complete.

The user registration may be performed when the client application 13 is not installed, for example, when the user first posts the label data or when the user first downloads the label data. Alternatively, user registration may be performed by directly accessing a web page provided by the label management server 22 via a browser without using the client application 13.

### (2. Content Registration Step)

Next, a user registration step for registering contents that can be arranged on a label in the content DB 26 will be described. On the label, various contents customized by the user can be arranged in addition to general contents such as text and graphics. Examples include image objects in which a logo mark, a character image, a decoration image, or a two-dimensional code is drawn. Other examples include objects in which a table, a graph, or a figure having a special shape is drawn. In the system 100, such contents customized by the user can be shared. Therefore, the user who provides the content registers the content in the label management server 22 via the client application 13, for example.

For example, when the user logs in to the label management server 22 via the client application 13 and requests content registration from the terminal 12 to the label management server 22 via the client application 13, the label management server 22 requests input of content data indicating the content to be uploaded, a print condition, and an adjustment mode. Thereafter, upon accepting a content registration instruction in a state where such information is input via the client application 13, the label management server 22 registers new content information in the content DB 26 based on the input information.

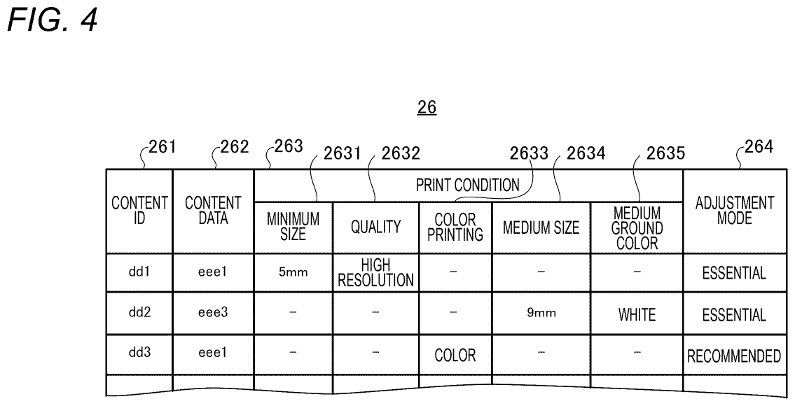

Specifically, as illustrated in FIG. 4, a record of content can be registered in the content DB 26. The record of content registered in the content DB 26 includes a content ID 261, content data 262, a print condition 263, and an adjustment mode 264. Further, the print condition 263 includes items such as a content minimum size 2631, a print quality 2632, color printing 2633, a print medium minimum size 2634, and a print medium ground color 2635. Upon accepting the registration instruction of the content, the label management server 22 creates a record in which the input content data, print condition, and adjustment mode are associated with the content ID for identifying the content, and newly registers the record in the content DB 26. Thus, the content registration procedure is complete.

The print condition 263 included in the record of the content is a condition for printing the label data including the content, and the client application 13 is configured to perform adjustment for following the print condition. The adjustment for following the print condition is executed, for example, when label data including the content is edited or when the label data is printed.

The print condition 263 includes a plurality of items and is set as necessary. The items of the print condition 263 include, for example, the content minimum size 2631, the print quality 2632, the color printing 2633, the print medium minimum size 2634, and the print medium ground color 2635 as described above. The content minimum size 2631 defines the content minimum size of the target, and the size of the content is adjusted so as not to fall below this size. By defining the content minimum size, it is possible to prevent the content from becoming too small and the content from becoming unclear.

The print quality 2632 defines the quality when printing, and is settable to “high resolution” in the present embodiment. If set to “high resolution”, adjustment is performed such that the print quality of the print setting is set to “high resolution”. By defining the print quality, it is possible to avoid low-quality printing.

The color printing 2633 defines whether printing is color or monochrome, and is settable to “color” or “monochrome” in the present embodiment. For example, if set to “color”, adjustment is performed such that “color” is set as the designation of color or monochrome in the print setting. By specifying color or monochrome, printing suitable for the content can be expected.

The print medium minimum size 2634 defines the print medium minimum size set in the label data, and the size of the print medium is adjusted so as not to fall below this size. The print medium minimum size 2634 may define the width, the length, or both. By defining the print medium minimum size, it is possible to avoid a problem that the print medium becomes too small and a part of the content is not printed.

The print medium ground color 2635 defines the print medium ground color set in the label data, and adjustment is performed such that the print medium ground color is this color. By defining the print medium ground color, it is possible to prevent the content and the print medium from being similar in color and being unclear.

The items of the print condition 263 are set as necessary, and “-” is stored for the items that are not set. The items of the print condition 263 are not limited thereto, and some items may not be included or other items may be included. The other items may include, for example, the ink color and the image processing (dither, error diffusion, binary).

As in the present embodiment, by including the self-condition related to the content itself such as the content minimum size 2631 in the print condition 263 and performing adjustment to satisfy the self-condition, it can be expected to avoid printing with settings unsuitable for the content.

In addition, by including print parameter conditions related to print setting parameters related to the parameters of the print setting such as the print quality 2632 and the color printing 2633 in the print condition 263, and adjusting the parameters of print setting to satisfy the print parameter conditions, it can be expected to avoid printing with print settings unsuitable for the content.

In addition, by including medium conditions related to the print medium such as the print medium minimum size 2634 and the print medium ground color 2635 in the print condition 263 and adjusting the setting of the print medium included in the label data to satisfy the medium conditions, it can be expected to avoid printing on a print medium unsuitable for printing the content.

The adjustment for following the print condition includes two modes including: “essential” of prohibiting a setting other than the designated print condition; and “recommended” of issuing a warning without prohibiting the setting if the setting is other than the designated print condition. The adjustment mode 264 included in the record of the content sets whether the processing for adjustment for following the print condition is “essential” or “recommended”. “Essential” is an example of a “first mode” of the adjustment based on the print condition, and “recommended” is an example of a “second mode” of the adjustment based on the print condition. Details of the processing of each mode will be described later.

The print condition 263 and the adjustment mode 264 of the content allows editing of the record of the content registered in the content DB 26 not only upon the registration of the content but also after the registration.

The contents registered in the content DB 26 allows the registration of not only contents uploaded by the user but also contents prepared by the vendor, which is the printer manufacturer, and print conditions and adjustment modes for such content can be set as well.

### (3. Content Download Step)

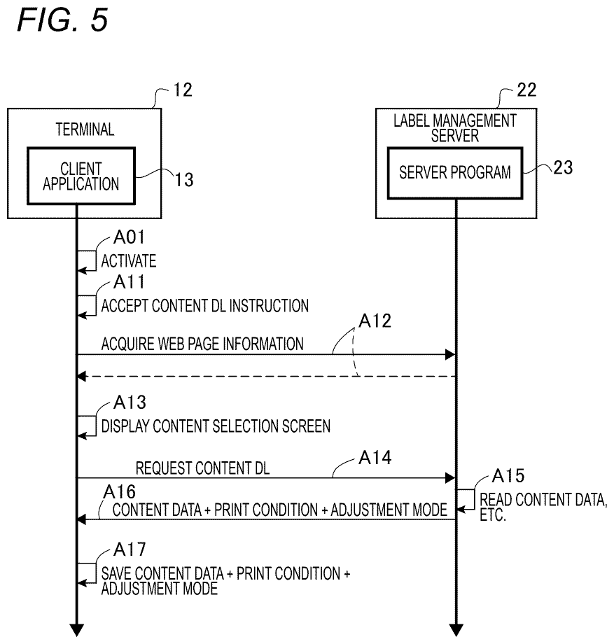

Next, a content download step will be described with reference to the sequence diagram of FIG. 5. The terminal 12 activates the client application 13 based on a user operation (A01).

When the client application 13 is activated, the terminal 12 requests input of a user ID, logs in to the label management server 22 using the input user ID, and displays a home screen of the client application 13 when the login is successful. The home screen of the client application 13 is configured to accept instructions for registering contents, downloading contents, posting label data, downloading label data, and editing a label. For example, upon accepting an instruction for content registration, the terminal 12 proceeds to the content registration step described above.

Upon accepting a content download instruction (A11), the terminal 12 acquires a web page of a content selection screen provided by the server program 23 (A12) and displays the content selection screen (A13). For example, when the client application 13 has a browser function, the client application 13 accesses the label management server 22 using the browser function of the client application 13 and causes the terminal 12 to display the content selection screen. When the client application 13 does not have a browser function, the client application 13 passes a URL to another program such as a browser installed in the terminal 12, and causes the terminal 12 to display the content selection screen by the other program. The content selection screen includes a list of contents registered in the content DB 26, and can accept the selection of contents to be downloaded and a download instruction of the selected content.

Upon accepting the download instruction via the content selection screen, the terminal 12 requests download of the selected content via the client application 13 (A14). Upon accepting the request, the label management server 22 reads the content data, the print condition, and the adjustment mode corresponding to the selected content from the content DB 26 (A15), and responds the read content data, print condition, and adjustment mode to the terminal 12 of the request source (A16). A14 and A16 are an example of “content download processing”. A16 is an example of “acquisition processing”.

Upon acquiring the content data, the print condition, and the adjustment mode from the label management server 22, the terminal 12 saves the acquired content data in the memory 122 in association with the acquired print condition and adjustment mode (A17). Accordingly, on the terminal 12, the downloaded content can be used in editing the label data in the client application 13. In addition, in downloading label data to be described later, label data including downloaded contents can be downloaded. A17 is an example of a “saving processing”.

### (4. Label Data Editing Step and Posting Step)

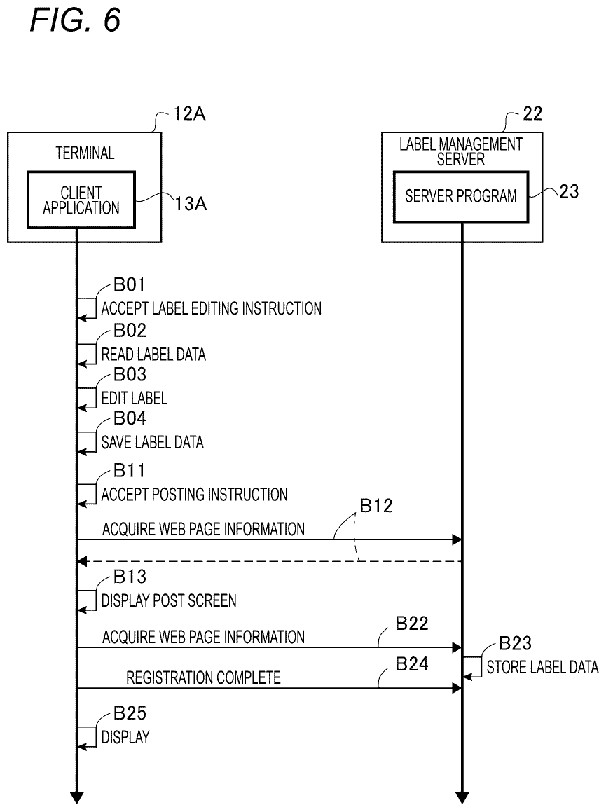

Next, the label data editing step and posting step will be described with reference to the sequence diagram of FIG. 6. In the following description, it is assumed that the terminal 12A edits and posts the label data.

Upon accepting an editing instruction of the label data after activating the client application 13A (B01), the terminal 12A displays an edit screen of the client application 13A, accepts selection of the label data to be edited, and reads the selected label data (B02). When the label data is newly created, selection and reading of the label data are not performed.

Upon reading the label data, the terminal 12A accepts editing of the label based on the label data via the edit screen (B03). In the editing of the label, setting of attribute information on the label, arrangement of objects, setting of parameters that are settable for the objects, a save instruction of label data, and a print instruction of the label data are accepted. In the label, the contents saved in the terminal 12A can be arranged in addition to general objects such as a text object. The label attribute information includes, for example, a label width, a label ground color, a character color, and a label type. Examples of the label type include laminate tape, masking tape, cloth tape, and ribbon. B03 is an example of “editing acceptance processing”.

Upon accepting the save instruction via the edit screen, the terminal 12A saves the label data indicating the edited label (B04). When the content downloaded from the label management server 22 is arranged on the edited label, the label data including the content is saved.

On the other hand, upon accepting a posting instruction of the label data (B11) after activating the client application 13A, the terminal 12A acquires a web page of a post screen provided by the server program 23 (B12) and displays the post screen (B13). In the post screen, selection of label data as the posting target and an upload instruction of the selected label data can be accepted. The post screen also accepts input of detailed information about the selected label data, for example, the label name, the use, and the description.

Upon accepting the upload instruction via the post screen, the terminal 12A reads the selected label data (hereinafter, referred to as “posted label data”) and uploads the read posted label data to the label management server 22 (B22). The label management server 22 registers the uploaded label data in the label DB 27 in association with the user ID of the login user (B23). B22 is an example of “upload acceptance processing”.

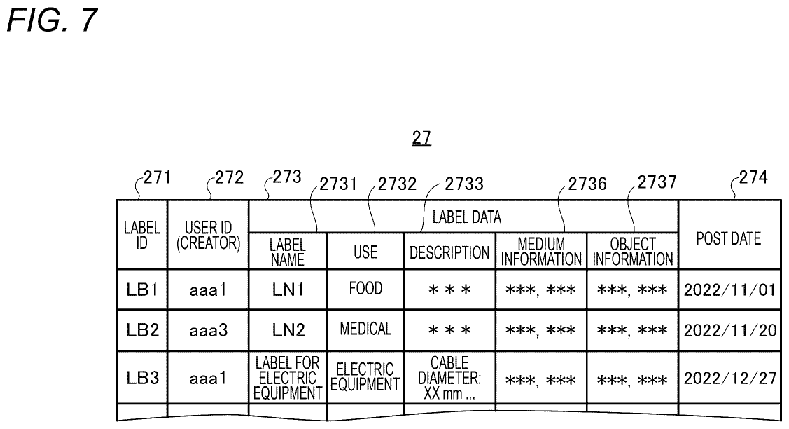

Specifically, as illustrated in FIG. 7, a record of label data can be registered in the label DB 27. The record of the label data registered in the label DB 27 includes a label ID 271, a user ID (creator) 272, label data 273, and a post date 274.

The label data 273 is configured to store information related to the label. The label data 273 includes, for example, a label name 2731, a use 2732, a description 2733, medium information 2736, and object information 2737. The label name 2731 is configured to store the label name. The use 2732 is configured to store information indicating the use of the label. The description 2733 is configured to store information indicating the description of the label. The medium information 2736 is configured to store information related to the label and the print medium. The object information 2737 is configured to store information related to an object arranged on the label.

When the registration of the posted label data is complete, the label management server 22 notifies the terminal 12A, which is the transmission source of the posted label data, of registration complete (B24). The terminal 12A displays a registration complete notification (B25).

The label data registered in the label DB 27 allows the registration of not only posted label data uploaded by the user but also label data prepared by the vendor, which is the printer manufacturer, and information for such label data can be set as well. If the creator of the label data is the vendor of the printer, the user ID 272 may store nothing or store information for identifying the vendor.

### (5. Label Data Download Step)

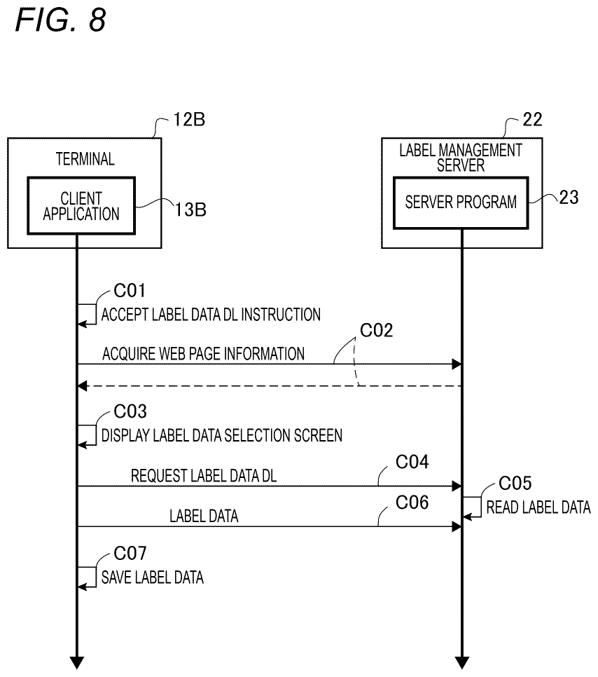

Next, a label data download step will be described with reference to the sequence diagram of FIG. 8. In the following description, it is assumed that the terminal 12B downloads label data from the label management server 22.

Upon accepting a download instruction of the label data after activating the client application 13B (C01), the terminal 12B acquires a web page of a label data selection screen provided by the server program 23 (C02) and displays the label data selection screen (C03). The label data selection screen includes a list of label data registered in the label DB 27, and is configured to accept the selection of label data to be downloaded and a download instruction of the selected label data. Among the label data registered in the label DB 27, label data including contents not saved in the terminal 12B is restricted from being downloaded. The mode for restricting the download may be making such label data unselectable or undownloadable, or warning at the time of selection or download.

Upon accepting the download instruction via the label data selection screen, the terminal 12B requests the label management server 22 to download the selected label data (C04). Upon accepting the request, the label management server 22 reads the selected label data from the label DB 27 (C05), and responds the read label data to the terminal 12B, which is the request source (C06). C04 and C06 are an example of “label download processing”.

Upon acquiring the label data from the label management server 22, the terminal 12B saves the acquired label data in the memory 122 (C07). Accordingly, on the terminal 12, the downloaded label data can be selected as the editing target in editing the label data in the client application 13.

### (6. Printing Step)

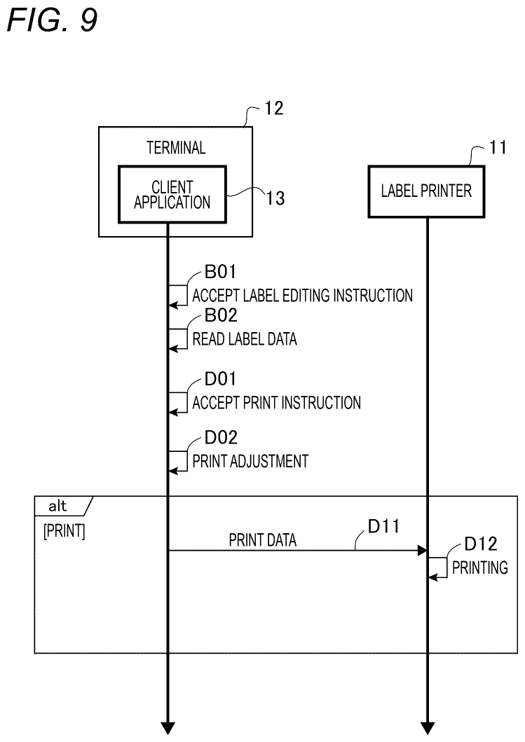

Next, a label data printing step will be described with reference to FIG. 9. Since the printing step is performed on both the poster side and the printing person side, in the following description, the terminal 12A of the poster and the terminal 12B of the printing person are described as the terminal 12 without being distinguished. Upon accepting an editing instruction of the label data after activating the client application 13 (B01), the terminal 12 displays an edit screen of the client application 13, accepts selection of the label data to be edited, and reads the selected label data (B02). B01 and B02 are the same as those described in the label editing and posting step. The selected label data may be, for example, posted label data or downloaded label data.

Upon accepting the save instruction via the edit screen (D01), the terminal 12 performs print adjustment of determining whether to print the label data indicating the edited label (D02). D01 is an example of “print acceptance processing”. Details of D02 will be described later.

When it is determined to perform printing in D02, the terminal 12 generates print data based on the label data being edited and transmits the generated print data to the label printer 11 (D11). The label printer 11 performs printing based on the received print data (D12).

### [Adjustment for Following Print Conditions]

Next, adjustment for following the print conditions set for each content in the terminal 12 will be described. The scenes of performing the adjustment include a scene of editing label data in which the content is arranged (B03 in FIG. 6) and a scene of issuing a label print instruction (D02 in FIG. 9). By performing adjustment to satisfy the print conditions in the scene of editing the label, it is possible to avoid editing unsuitable for the content. By performing adjustment to satisfy the print conditions in the scene of issuing a print instruction, it is possible to avoid printing under print conditions unsuitable for the content. Hereinafter, each scene will be described separately.

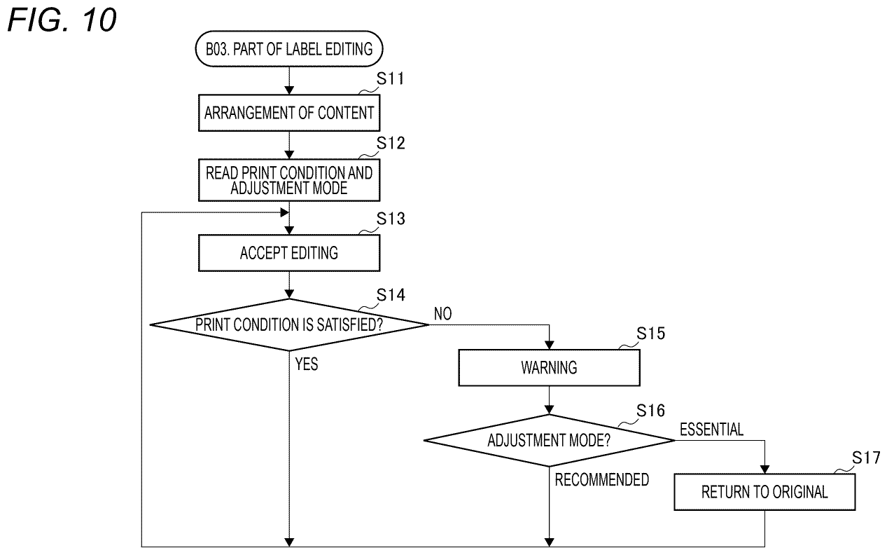

First, adjustment in a scene of editing label data in which content is arranged will be described with reference to the flowchart of FIG. 10. In the scene of editing the label data, the terminal 12 arranges the content included in the read label data on the label via the edit screen of the client application 13 (step S11), and reads the print condition and the adjustment mode corresponding to the arranged content from the memory 122 (step S12). During the editing of the label data, the print condition and the adjustment mode corresponding to the newly arranged content are similarly read from the memory 122.

Thereafter, when a change to the label data is accepted (step S13), the terminal 12 determines whether the change satisfies the print condition (step S14). For example, in a case where the content minimum size is set as the print condition, it is determined that the print condition is not satisfied when the width of the content after the change becomes smaller than the width of the minimum size due to a change in the width of the content. The change of the width of the content includes not only a case where the width of the content is changed directly but also a case where the width of the content is changed automatically according to a change in the width of the label. In addition, for example, if the print medium minimum size is set as the print condition, it is determined that the print condition is not satisfied if the width of the print medium after the change becomes smaller than the width of the minimum size due to a change in the width of the label. It is not necessary to determine the print conditions for all the items. For example, the items related to the print setting (print quality and color printing in the present embodiment) do not need to be determined. When it is determined that the print condition is satisfied (step S14: YES), the terminal 12 accepts the change and proceeds to step S13 to wait for the next operation.

It is determined that the print condition is satisfied when no print condition corresponding to the content is saved, or when a print condition is saved but no item as the determination target is set. When there are a plurality of contents, it is determined in step S14 that the print condition is satisfied if all the contents satisfy the print condition, and it is determined in step S14 that the print condition is not satisfied when the print condition of at least one content is not satisfied.

When it is determined that the print condition is not satisfied (step S14: NO), the terminal 12 warns that the change does not satisfy the print condition set for the content (step S15). Further, the type of the adjustment mode associated with the content determined as not satisfying the print condition is determined (step S16). When the type of the adjustment mode is “essential” (step S16: essential), the changed content is returned to the original content (step S17), and the process proceeds to step S13 to wait for the next operation. For example, when the detail of the change is a change in the width of the content, the width of the content is returned to the original width. In this way, when the adjustment mode is “essential”, adjustment is performed to satisfy the print condition by canceling changes that do not satisfy the print condition. In this case, step S17 is an example of “adjustment processing”.

On the other hand, when the type of the adjustment mode is “recommended” (step S16: recommended), the process proceeds to step S13 to wait for the next operation without returning the changed content to the original content. That is, a warning is issued without cancelling the change, and the user is entrusted to decide whether to return the change to the original state according to the warning. Accordingly, a change by the user can be prioritized over the print condition of the content. However, since the warning is issued, the user can be expected to make a change returning to the original state, thereby performing indirect adjustment to satisfy the print condition. In this case, step S15 is an example of “adjustment processing”.

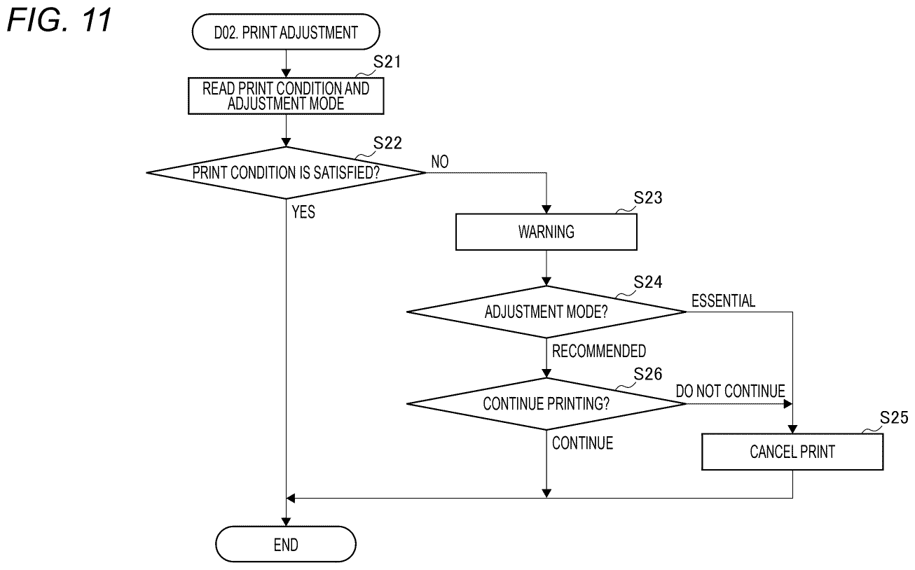

Next, adjustment in a scene of issuing a label print instruction will be described with reference to the flowchart of FIG. 11. In a scene in which there is a print instruction of the label data, the terminal 12 reads the print condition and the adjustment mode corresponding to the content included in the label data from the memory 122 (step S21).

Then, the terminal 12 determines whether the print setting by the print instruction satisfies the print condition of the content (step S22). For example, when “high resolution” is set as the print quality as the print condition, it is determined that the print condition is not satisfied if “high resolution” is not set as the print setting. In addition, for example, when “white” is set as the print medium ground color, it is determined that the print condition is not satisfied if no print medium having a ground color “white” is set. It is not necessary to determine the print conditions for all the items. For example, the items related to the size of the content can be determined at the time of editing, and thus do not need to be determined at the time of printing. When it is determined that the print condition is satisfied (step S22: YES), the terminal 12 determines to perform printing, proceeds to D11 (see FIG. 9), and performs printing by the label printer 11.

As in the scene of editing the label data, it is determined that the print condition is satisfied if no print condition corresponding to the content is saved, or if a print condition is saved but no item as the determination target is set. When there are a plurality of contents, it is determined in step S22 that the print condition is satisfied if all the contents satisfy the print condition, and it is determined in step S22 that the print condition is not satisfied if the print condition of at least one content is not satisfied.

When it is determined that the print condition is not satisfied (step S22: NO), the terminal 12 warns that the print setting does not satisfy the print condition set for the content (step S23). Then, the terminal 12 determines the type of the adjustment mode associated with the content determined as not satisfying the print condition (step S24). When the type of the adjustment mode is “essential” (step S24: essential), the terminal 12 determines not to perform printing and cancels printing according to the print instruction (step S25). When the adjustment mode is “essential” as described above, the user can be expected to change the print setting by canceling the printing based on the print instruction, thereby performing adjustment to satisfy the print condition. In this case, step S25 is an example of “adjustment processing”.

On the other hand, when the type of the adjustment mode is “recommended” (step S23: recommended), an instruction as to whether to continue printing based on the print instruction is accepted instead of canceling the printing (step S26). That is, the user determines whether to continue the printing. Then, when it is instructed not to continue (step S26: not to continue), the terminal 12 determines not to perform printing and cancels printing according to the print instruction (step S25). On the other hand, when it is instructed to continue (step S26: continue), the terminal 12 determines to perform printing, proceeds to D11 (see FIG. 9), and performs printing by the label printer 11. Accordingly, printing under the print setting can be prioritized over the print condition of the content. That is, a warning is issued but the user is entrusted to continue printing by inquiring whether to continue printing. Accordingly, the printing is not prohibited, and the degree of freedom in using the content is not narrowed. Step S23 and step S26 are an example of “adjustment processing”.

As described above, the client application 13 of the present embodiment causes the terminal 12 to acquire the print condition of the content from the label management server 22 and save the print condition. When the content is used, the terminal 12 is caused to adjust various settings to satisfy the print conditions of the content. As a result, when the label data is printed by the client application 13, printing under a print condition suitable for the content can be expected. As a result, for example, it can be expected to save the waste of consumables due to printing under inappropriate print conditions and the trouble for reprinting.

In addition, since the client application 13 causes the terminal 12 to acquire the print condition of the content when downloading the content, the print condition is adjusted based on the print condition set for the content when the downloaded content is used, so that suitable printing of the downloaded content can be expected.

In adjustment for following the print condition for each content by the client application 13, different adjustment modes can be selected between “essential” and “recommended”. In “essential”, since a change or printing that does not satisfy the print condition is prohibited, as a result, printing under a print condition suitable for the content can be expected. On the other hand, in “recommended”, a change that does not satisfy the print condition or printing is not prohibited, but a warning is issued, so that a change by the user can be expected. Further, by stopping the warning, the degree of freedom in using the content is not narrowed.

The embodiments disclosed in the present specification are merely an example, and does not limit the present invention. Therefore, various improvements and modifications can be naturally made to the technique disclosed in the present specification without departing from the gist of the present invention. The number of label printers 11 connected to the terminal 12 is not limited to the illustrated example, and may be two or more.

In the embodiment, the print condition of the content is acquired and saved at the timing of downloading the content data, but the timing of acquiring the print condition of the content is not limited thereto. For example, the print condition of the content may be acquired by inquiring the label management server 22 at the timing of arranging the content on the label.

In the embodiment, one adjustment mode is associated with each print condition including a plurality of items, but an adjustment mode may be associated with each item of each print condition. In this case, the adjustment mode can be changed for each item of the print condition.

In the embodiment, the download of label data including contents not stored in the terminal 12 is restricted, but may not be restricted. That is, the download of the label data may be permitted.

In the embodiment, the content data, the print conditions related to the content data, and the adjustment mode are saved based on the instruction from the content selection screen as illustrated in FIG. 5, but may be saved based on the download of the label data illustrated in FIG. 8. That is, when label data including a content that is not stored in the terminal 12 is downloaded, the content included in the label data and the print conditions and the adjustment mode related to the content may also be downloaded and saved.

In any sequence diagram disclosed in the embodiments, an execution order of any plurality of processes can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

What is claimed is:

1. A non-transitory computer readable storage medium storing a program configured to be executed by an information processing device configured to connect to a label printer,
wherein the program comprising instructions that, when executed by a computer of the information processing device, causes the computer to execute:
acquisition processing of acquiring a print condition corresponding to a predetermined content from a server; and
saving processing of saving the print condition acquired in the acquisition processing in association with the predetermined content,
a print condition for each content configured to be included in label data is configured to be registered to the server,
in a case where the server received a request related to the predetermined content from the information processing device, the server responds the print condition corresponding to the predetermined content to the information processing device, and
the instructions cause the computer of the information processing device to further execute, in a case where the predetermined content in which the print condition is saved is used, adjustment processing of performing adjustment to satisfy the saved print condition.

2. The non-transitory computer readable storage medium according to claim 1,
wherein the print condition includes a medium condition related to a print medium, and
in the adjustment processing, in a case where the predetermined content in which the medium condition is saved as the print condition is used, a setting of the print medium included in the label data is adjusted to satisfy the saved medium condition.

3. The non-transitory computer readable storage medium according to claim 1,
wherein the print condition includes a print parameter condition related to a parameter of a print setting, and
in the adjustment processing, in a case where the predetermined content in which the print parameter condition is saved as the print condition is used, the parameter of the print setting is adjusted to satisfy the saved print parameter condition.

4. The non-transitory computer readable storage medium according to claim 1,
wherein the print condition includes a self-condition related to the predetermined content itself, and
in the adjustment processing, in a case where the predetermined content in which the self-condition is saved as the print condition is used, a setting of the predetermined content is adjusted to satisfy the saved self-condition.

5. The non-transitory computer readable storage medium according to claim 1,
wherein the instructions cause the computer of the information processing device to:
execute print acceptance processing of accepting a print instruction of label data;
in a case where the print instruction is accepted, determine whether the print condition corresponding to the content included in the label data to be printed is saved; and
in a case where the computer determine that the print condition is set, execute the adjustment processing.

6. The non-transitory computer readable storage medium according to claim 1,
wherein the instructions cause the computer of the information processing device to:
execute editing acceptance processing of accepting an editing instruction of label data;
in a case where the editing instruction is accepted, determine whether the print condition corresponding to the content included in the label data to be edited is saved; and
in a case where the computer determine that the print condition is set, execute the adjustment.

7. The non-transitory computer readable storage medium according to claim 1,
wherein the instructions cause the computer of the information processing device to execute:
content download processing of transmitting a download request related to the predetermined content to the server and of receiving the predetermined content transmitted from the server in response to the download request,
in a case where the server receives the download request from the information processing device, the server transmits the predetermined content to the information processing device in association with the print condition corresponding to the predetermined content, and
in the acquisition processing, the computer acquires the print condition received from the server in association with the predetermined content received in the content download.

8. The non-transitory computer readable storage medium according to claim 1,
wherein the instructions cause the computer of the information processing device to execute:
upload processing of uploading first label data saved in the information processing device to the server,
the first label data is configured to include the predetermined content,
the server registers the first label data uploaded from the information processing device in a label database,
the instructions cause the computer of the information processing device to execute:
label download processing of requesting the server to transmit second label data registered in the label database and of receiving the second label data transmitted from the server, and
the second label data is configured to include the predetermined content.

9. The non-transitory computer readable storage medium according to claim 1,
wherein in the adjustment processing, printing is prohibited in a case where the saved print condition is not satisfied.

10. The non-transitory computer readable storage medium according to claim 1,
wherein in the adjustment processing, a change to a condition that does not satisfy the saved print condition is prohibited.

11. The non-transitory computer readable storage medium according to claim 1,
wherein in the adjustment processing, a warning is issued via a user interface of the information processing device in a case where the saved print condition is not satisfied.

12. The non-transitory computer readable storage medium according to claim 1,
wherein the print condition is associated with an operation setting indicating whether to perform adjustment based on the print condition in a first mode or a second mode, and
in the adjustment processing, in a case where the operation setting indicating the first mode is associated with the print condition,
in a case where the saved print condition is not satisfied, printing is prohibited and a change to a condition that does not satisfy the saved print condition is prohibited, and
in a case where the operation setting indicating the second mode is associated with the print condition,
in a case where the saved print condition is not satisfied, a warning is issued via a user interface of the information processing device.

13. An information processing device for being connected to a label printer,
wherein the information processing device is configured to execute:
acquisition processing of acquiring a print condition corresponding to a predetermined content from a server; and
saving processing of saving the print condition acquired in the acquisition processing in association with the predetermined content,
a print condition for each content configured to be included in label data is configured to be registered to the server,
in a case where the server receives a request related to the predetermined content from the information processing device, the server responds the print condition corresponding to the predetermined content to the information processing device, and
the information processing device is further configured to execute, in a case where the predetermined content for which the print condition is saved is used, adjustment processing of performing adjustment to satisfy the saved print condition.

14. A system comprising:
an information processing device; and
a server,
wherein the information processing device is configured to connect to the server via a network,
the server is configured to:
register a print condition for each content configured to be included in label data; and
in a case where the server receives a request related to a predetermined content from the information processing device, respond the print condition corresponding to the predetermined content to the information processing device,
the information processing device is configured to:
acquire the print condition corresponding to the predetermined content from the server; and
save the acquired print condition in association with the predetermined content, and
the information processing device is further configured to perform, in a case where the predetermined content for which the print condition is saved is used, adjustment to satisfy the saved print condition.
